(19) United States
(12) Patent Application Publication
(10) Pub. No.: US 2011/0153654 A1
(43) Pub. Date: Jun. 23, 2011

(54) NATURAL LANGUAGE-BASED TOUR DESTINATION RECOMMENDATION APPARATUS AND METHOD

(75) Inventor: Chung-Hee LEE, Daejeon (KR)

(73) Assignee: Electronics and Telecommunications Research Institute, Daejeon (KR)

(21) Appl. No.: 12/969,489

(22) Filed: Dec. 15, 2010

(30) Foreign Application Priority Data
Dec. 18, 2009 (KR) 10-2009-0126711

(51) Int. Cl. G06F 17/30

(52) U.S. Cl. 707/769; 707/E17.015

(57) ABSTRACT

Disclosed herein is a natural language-based tour destination recommendation apparatus and method. The natural language-based tour destination recommendation apparatus includes a query analysis unit, a tour destination search unit, and a tour destination recommendation and provision unit. The query analysis unit performs linguistic analysis on a user's tour-related query and then extracting query analysis information to be used for figuring out the user's intention from a document index DB. The tour destination search unit searches a tour destination DB for one or more recommended tour destinations using the extracted query analysis information. The tour destination recommendation and provision unit provides the retrieved recommended tour destinations to the user.

### CROSS REFERENCE TO RELATED APPLICATION

This application claims the benefit of Korean Patent Application No. 10-2009-0126711, filed on Dec. 18, 2009, entitled “Natural Language based Travel Recommendation Apparatus and Method using Location and Theme information,” which is hereby incorporated by reference in its entirety into this application.

### BACKGROUND OF THE INVENTION

1. Technical Field

The present invention relates generally to a natural language-based tour destination recommendation apparatus and a method using regional and thematic information, and, more particularly, to a natural language-based tour destination recommendation apparatus and a method using regional and thematic information which is configured to extract regional information, thematic information and other information by analyzing users' queries regarding tour information, to search for tour destinations corresponding to regions and themes, desired by users, using query analysis results, to prioritize tour destinations suitable for the users' intention using other information appearing in the users' queries, document search results, and previously constructed tour destination reliability information, and to recommend the tour destinations.

2. Description of the Related Art

In general, information provision systems, such as car navigation systems, are adapted to store map information indicative of the entire map and Point of Interest (POI) information indicative of famous spots, buildings and roads on the entire map therein and to provide the map information and the POI information to users.

Meanwhile, with the popularization of such car navigation systems, methods for providing a variety of types of information have been proposed. In particular, tour destination recommendation methods are adapted to enable tour information to be searched for when predefined profile information or schedule information is provided to systems, such as car navigation systems. Furthermore, additional information may be provided via an interactive system, like in a simple flight reservation function.

For example, a conventional tour destination recommendation method is implemented in such a way as to receive recommended tour destination information and provide the recommended tour destination information over a mobile communication network on an Internet Protocol (IP) basis. This method has limitations because it targets only subscribers to specific systems and is adapted to choose recommended tour destinations only based on the personal schedules and portal search histories of the subscribers. Another conventional tour destination recommendation method is adapted to provide region-based tour courses and Point of Interest (POI) information for each tour course via a user interface. This technology is specialized for car navigation, and recommends only surrounding Points of Interest (POIs) along a tour course.

Accordingly, the conventional tour destination recommendation methods have many limitations because they are adapted to search for and recommend tour information only based on previously constructed personal information, such as personal schedules, profiles and portal search histories.

### SUMMARY OF THE INVENTION

Accordingly, the present invention has been made keeping in mind the above problems occurring in the prior art, and an object of the present invention is to provide a natural language-based tour destination recommendation apparatus and method that is configured to, when users request desired information in a natural language, analyze the users' intention using linguistic analysis, search for tour destinations based on regions and themes desired by the users, and recommend the tour destinations to the users.

Another object of the present invention is to provide a natural language-based tour destination recommendation apparatus and method that is configured to prioritize retrieved tour destinations using document search results and predefined tour destination reliability information, thus being able to recommend optimum tour destinations.

In order to accomplish the above objects, the present invention provides a natural language-based tour destination recommendation apparatus, including a query analysis unit for performing linguistic analysis on a user's tour-related query and then extracting query analysis information to be used for figuring out the user's intention from a document index DB; a tour destination search unit for searching a tour destination DB for one or more recommended tour destinations using the extracted query analysis information; and a tour destination recommendation and provision unit for providing the retrieved recommended tour destinations to the user.

The query analysis information may include POI information, thematic information, regional information and/or other information.

The recommended tour destinations may include one or more region-based tour destinations, one or more theme-based tour destinations and/or one or more document searching-based tour destinations.

The natural language-based tour destination recommendation apparatus may further include a tour destination prioritization unit for prioritizing the recommended tour destinations using the reliability information of the document index DB.

The reliability information may include one or more of a document similarity score, a POI extraction reliability score, a tour destination reputation score, a tour information provision CP reliability score, a tour document-type reliability score, and other reliability scores.

The tour destination prioritization unit may filter out one or more tour destinations not corresponding to the user's tour-related query from the recommended tour destinations.

The natural language-based tour destination recommendation apparatus may further include a tour information extraction unit for classifying tour destinations on a theme or region basis and organizing the classified tour destinations into the tour destination DB.

The natural language-based tour destination recommendation apparatus may further include a document index unit for extracting an index term, a representative POI, document reliability and/or reputation information from each tour document and organizing the extracted information into the document index DB.

The query analysis unit may include a query linguistic analysis unit for performing linguistic analysis on the user's tour-related query using morpheme analysis and named entity recognition; a POI extraction unit for extracting POIs appearing in the user's tour-related query using the linguistic analysis results; a theme extraction unit for extracting thematic information of the user's tour-related query using the linguistic analysis results; and a region extraction unit for extracting regional limitation information of the user's tour-related query using the linguistic analysis results.

The query analysis unit may further include an other information extraction unit for extracting one or more query term or stop words using the linguistic analysis results so that they can be used for document searching for the user's tour-related query [symbol] document.

The tour destination search unit may include a region-based tour destination search unit for searching for tour destinations in a corresponding region based on regional limitation information of the user's tour-related query; and a theme-based tour destination search unit for searching for tour destinations related to a corresponding theme using thematic information of the user's tour-related query.

The tour destination search unit may further include a document-based tour destination search unit for searching for representative POIs of one or more corresponding tour documents based on the query term or stop word information of the user's tour-related query.

The tour destination search unit may further include a tour destination filtering unit for filtering out tour destinations not common to the retrieved groups of tour destination results.

The tour destination prioritization unit may include a document similarity-based prioritization unit for incorporating a similarity score of each tour document into reliability of a corresponding one of the recommended tour destinations; a POI extraction reliability-based prioritization unit for incorporating extraction reliability of a POI extracted from each tour document into reliability of a corresponding one of the recommended tour destinations; a tour destination reputation-based prioritization unit for incorporating reputation information of a tour destination in each document into reliability of a corresponding one of the recommended tour destinations; a tour information provision CP-based prioritization unit for incorporating reliability information of a professional tourist agency providing each piece of tour destination information into reliability of a corresponding one of the recommended tour destinations; a tour document type-based prioritization unit for incorporating a predetermined reliability score into reliability of a corresponding one of the recommended tour destinations a type of document retrieved by the document-based tour destination search unit; and an other information-based prioritization unit for incorporating additional tour destination-related information, such as image information, address information, user review information and/or user rating information, into reliability of a corresponding one of the recommended tour destinations.

The document index unit may include a document linguistic analysis unit for performing morpheme analysis and named entity recognition on refined documents provided by professional tourist agencies or web tour documents automatically collected from a web; an index term extraction unit for extracting significant keywords useful for searching using linguistic analysis results; a representative POI extraction unit for extracting POIs appearing in the documents, prioritizing the extracted POIs, and choosing principal POIs representative of the documents; a document reliability extraction unit for calculating reliability of the documents themselves based on sources, dates and document quality scores of the documents; and a reputation information extraction unit for extracting user reputation information from objects appearing in the documents and calculating reputation scores of the POIs.

The document index unit may further include an inverted index DB creation unit for constructing an inverted index DB so that all the extracted information can be used for searching.

Additionally, in order to accomplish the above objects, the present invention provides a natural language-based tour destination recommendation method, including performing linguistic analysis on a user's tour-related query and then extracting query analysis information to be used for figuring out the user's intention from a document index DB; searching a tour destination DB for one or more recommended tour destinations using the extracted query analysis information; and providing the retrieved recommended tour destinations to the user.

The query analysis information may include POI information, thematic information, regional information and/or other information.

The recommended tour destinations may include one or more region-based tour destinations, one or more theme-based tour destinations and/or one or more document searching-based tour destinations.

The natural language-based tour destination recommendation method may further include prioritizing the recommended tour destinations using the reliability information of the document index DB.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the overall configuration of a natural language-based tour destination recommendation apparatus according to the present invention;

FIG. 2 is a diagram showing the detailed configuration of a query analysis unit;

FIG. 3 is a diagram showing an example of the classification of POIs extracted by a POI extraction unit;

FIG. 4 is a diagram showing structured information, including a primary thematic category and a secondary thematic category, obtained by a theme extraction unit;

FIG. 5 is a diagram showing an example of query analysis results obtained by a query analysis unit;

FIG. 6 is a diagram showing the internal configuration of a tour destination search unit;

FIG. 7 is a diagram showing the internal configuration of a tour destination prioritization unit;

FIG. 8 is a diagram showing the internal configuration of a tour information extraction unit

FIG. 9 is a diagram showing the internal configuration of a document index unit;

FIG. 10 is a flowchart showing the flow of a natural language-based tour destination recommendation method according to the present invention;

FIG. 11 is a flowchart showing the detailed flow of step S10 of FIG. 10;

FIG. 12 is a flowchart showing the detailed flow of step S20 of FIG. 10; and

FIG. 13 is a flowchart showing the detailed flow of step S30 of FIG. 10.

### DESCRIPTION OF THE PREFERRED EMBODIMENTS

Preferred embodiments of the present invention will be described in detail below with reference to the accompanying drawings. The following description and accompanying drawings are given to provide a better understanding of the present invention. Detailed descriptions of known functions and components which may make the gist of the present invention unnecessarily obscure will be omitted below.

In summary, the present invention is configured to organize information required for the recommendation of tour destinations into DBs in advance, and to, when a user query is input, analyze the user's query, search for, prioritize and recommend the most suitable tour destinations in real time. The DBs used for searching includes a tour destination DB for storing region-based tour destinations or theme-based tour destinations extracted from structured information, and a document index DB for storing significant information extracted by performing linguistic analysis on the titles and bodies of tour-related text documents. A tour destination recommendation apparatus according to the present invention is configured to search for user query-related tour destinations using the query analysis results, find information required for the recommendation of tour destinations using DB searching, prioritize retrieved tour destinations according to a predefined prioritization policy, and finally recommend tour destinations most suitable for the user's intention in descending order of priority.

A natural language-based tour destination recommendation apparatus, to which a natural language-based tour destination recommendation method has been applied, according to an embodiment of the present invention will be described in detail below with reference to the attached drawings.

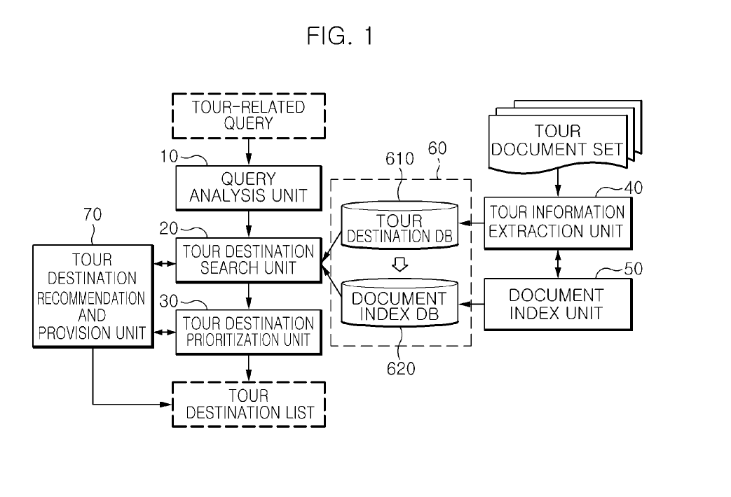

FIG. 1 is a diagram showing the overall configuration of a natural language-based tour destination recommendation apparatus according to an embodiment of the present invention.

The natural language-based tour destination recommendation apparatus, to which a natural language-based tour destination recommendation method has been applied, according to the embodiment of the present invention includes a query analysis unit 10, a tour destination search unit 20, a tour destination prioritization unit 30, a tour information extraction unit 40, a document index unit 50, a database (DB) 60, and a tour destination recommendation and provision unit 70. In summary, the natural language-based tour destination recommendation apparatus according to the embodiment of the present invention is configured to recommend tour destinations to users using natural linguistic analysis based on regional and thematic information.

The query analysis unit 10 extracts query analysis information required for the analysis of a user's intention by performing natural language (language) analysis on a tour-related query input by the user. That is, the query analysis unit 10 extracts query analysis information required for figuring out the user's intention from a document index DB 620 by performing linguistic analysis on the user's tour-related query.

Here, the term “natural language” is used to distinguish between a language which is used by people in their daily lives and an artificial language which is deliberately created for a specific purpose. That is, a user's tour-related query can be input on a natural language basis. For example, an example of such a query may be “recommend valleys in Japan which are fit for my family to go.”

Furthermore, the pieces of query analysis information may include POI information, thematic information, regional information and other information. Accordingly, the query analysis unit 10 extracts pieces of query analysis information required for figuring out the user's intention by performing natural linguistic analysis (which will be described later) on the user's tour-related query input in a natural language.

Furthermore, the user's tour-related query may be received through a user interface (not shown). For example, when the present invention is applied to navigation or tour software, a keypad or a touchpad may be employed.

The tour destination search unit 20 searches for related tour destinations using the extracted query analysis results. That is, the tour destination search unit 20 searches the tour destination DB 610 for one or more recommended tour destinations suitable for the user's intention using the extracted pieces of query analysis information.

Here, the recommended tour destinations may include region-based tour destinations, theme-based tour destinations and document searching-based tour destinations. Accordingly, the tour destination search unit 20 searches the above-described tour destination DB 610 for pieces of tour destination information corresponding to the pieces of query analysis information.

The tour destination prioritization unit 30 prioritizes the retrieved tour destinations using various document analysis results and previously calculated tour destination reliability information. That is, the tour destination prioritization unit 30 prioritizes the above-described one or more recommended tour destinations using the reliability information of the document index DB 620. Accordingly, the tour destination prioritization unit 30 can present tour destinations suitable for the user's query finally.

Here, the reliability information may include a document similarity score, a POI extraction reliability score, a tour destination reputation score, a tour information provision CP reliability score, a tour document-type reliability score, and other reliability scores.

Furthermore, it is preferred that the tour destination prioritization unit 30 filter out tour destinations not corresponding to the user's tour-related query from the one or more recommended tour destinations. Here, the filtering may be performed using an intersection between the above-described pieces of query analysis information. For example, the intersection may be the condition “regional tour destination results AND thematic tour destination results AND document-based tour destination results.”

The tour destination recommendation and provision unit 70 provides recommended tour destinations suitable for the above-described user's tour-related query finally. The tour destination recommendation and provision unit 70 may use any method for providing recommended tour destinations to a user. For example, the tour destination recommendation and provision unit 70 may provide recommended tour destinations to a user monitor in the form of a recommended tour destination list displayed on a monitor.

The DB 60 includes the document index DB 620 and the tour destination DB 610, and stores the above-described region and theme-based tour information used in the present invention.

The tour information extraction unit 40 constructs the tour destination DB 610 required for the searching of tour destinations. The tour information extraction unit 40 extracts theme-based tour destination information and region-based tour destination information from the tour information provided by professional tourist agencies and the structured information automatically extracted from the web. Furthermore, the tour information extraction unit 40 organizes the extracted information into the tour destination DB 610. That is, the tour information extraction unit 40 classifies tour destinations according to theme or region based on the structured information provided by professional tourist agencies and/or the structured information automatically extracted from the web, and establishes the tour destination DB 610 using the classification results.

The document index unit 50 constructs index terms and other tour document information by performing linguistic analysis on possessed tour documents in advance so as to enable documents suitable for user queries to be retrieved, and stores them in the document index DB 620. That is, the document index unit 50 extracts index terms, representative Points of Interest (POIs), document reliability and/or reputation information from the tour documents provided by the professional tourist agencies or collected from the web, and constructs the document index DB 620 using the extracted information.

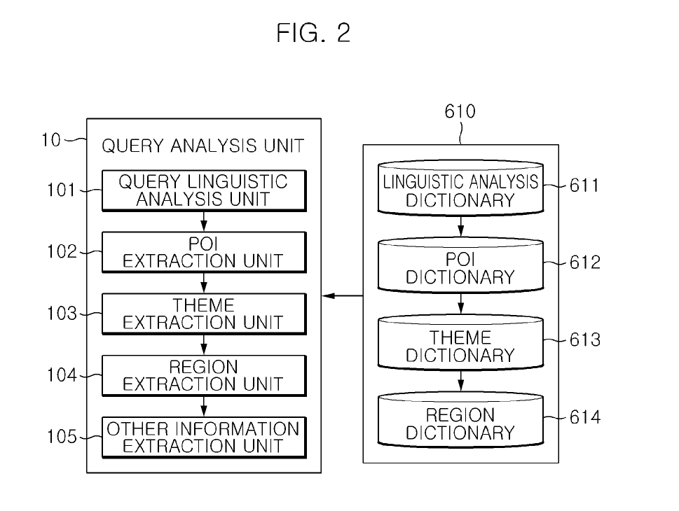

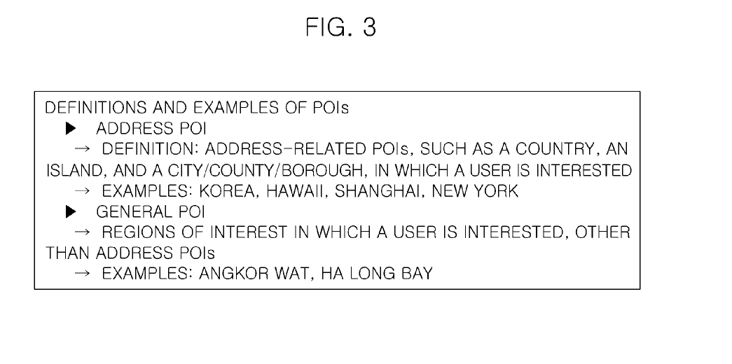

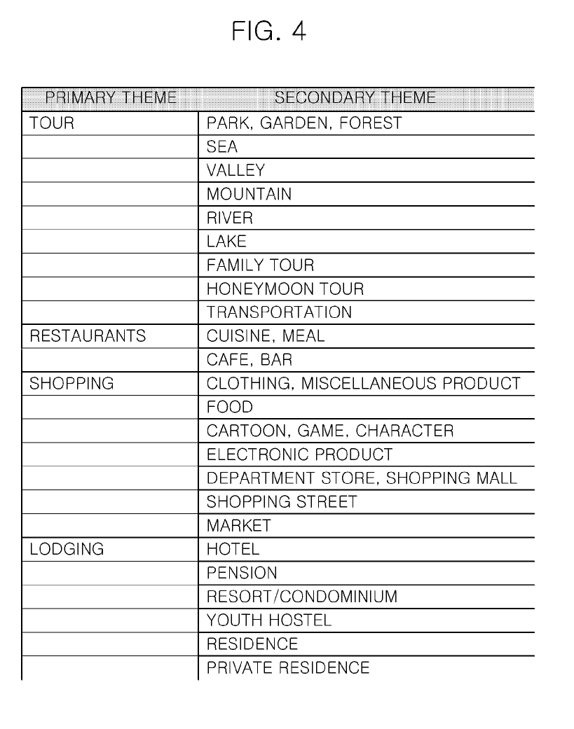

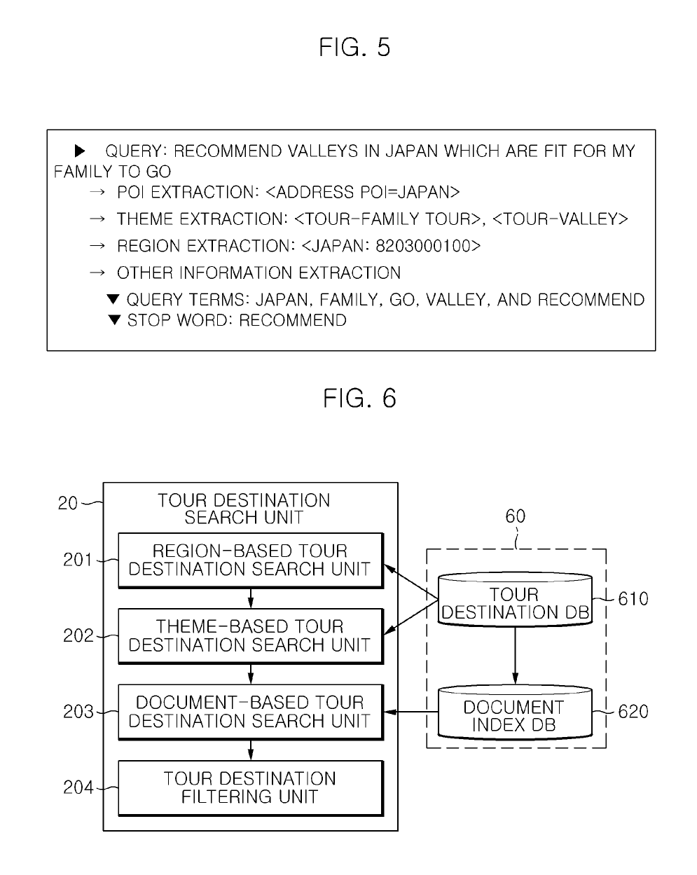

FIG. 2 is a diagram showing the detailed configuration of the query analysis unit, FIG. 3 is a diagram showing an example of the classification of POIs extracted by the POI extraction unit, FIG. 4 is a diagram showing structured information, including a primary thematic category and a secondary thematic category, obtained by the theme extraction unit, and FIG. 5 is a diagram showing an example of query analysis results obtained by the query analysis unit.

Referring to FIG. 2, the query analysis unit 10 includes a query linguistic analysis unit 101, a POI extraction unit 102, a theme extraction unit 103, a region extraction unit 104, and an other information extraction unit 105.

In this diagram, it is preferred that the tour destination DB 610 be configured to be divided into a linguistic analysis dictionary 611, a POI dictionary 612, a theme dictionary 613, and a region dictionary 614. Accordingly, data groups to be searched are classified for the respective units of the query analysis unit 10, so that search speed and accuracy can be increased. Since this can be easily understood, a detailed description thereof is omitted here.

The query linguistic analysis unit 101 performs morpheme analysis or named entity recognition on a user's tour-related query. That is, the query linguistic analysis unit 101 performs linguistic analysis using a method of dividing a user's tour-related query into morphemes or matching named entities to respective words.

The POI extraction unit 102 extracts one or more POIs, appearing in the above-described user's tour-related query, using the linguistic analysis results for the query. Generally, the term “POI” refers to a term representative of famous region, building or road information.

As shown in FIG. 3, in the present invention, extracted POIs are basically classified into general POIs and address POIs. That is, these address POIs are address-related POIs, such as a country, an island, and a city/county/borough, in which a user is interested (for example, Korea, Hawaii, Shanghai, New York, etc.). In contrast, these general POIs are regions of interest in which a user is interested, other than address POIs (for example, Angkor Wat, Ha Long Bay, etc.). The above examples are illustrative, and the present invention is not limited thereto.

The theme extraction unit 103 functions to select one from among predefined theme categories for the theme of a query. That is, the theme extraction unit 103 extracts thematic information using the linguistic analysis results for the above-described user's tour-related query.

Here, as shown in FIG. 4, the theme classification may include structured information including a primary theme and a secondary theme. For example, the theme extraction unit 103 classifies the primary theme of the user's tour-related query as lodging when the query includes a lodging-related result, such as a hotel, a pension, a resort/condominium, a youth hostel, a residence, or a private residence. This thematic structure is an example, and the present invention is not limited thereto.

The region extraction unit 104 extracts regional information appearing in a query using linguistic analysis results. That is, the region extraction unit 104 extracts the regional limitation information of a user's tour-related query using linguistic analysis results. Furthermore, the region extraction unit 104 may store a predefined regional code value.

The other information extraction unit 105 stores keyword information which can be used for document searching or filtering. That is, the other information extraction unit 105 extracts one or more query terms or stop words using the linguistic analysis results so that they can be used for document searching for the user's tour-related query.

An example of query analysis results obtained by the above-described query analysis unit is shown in FIG. 5. That is, it is assumed that the user's tour-related query “recommend valleys in Japan which are fit for my family to go” has been input. Then, the POI extraction unit 102 extracts <address POI=Japan> from the corresponding tour-related query, and the theme extraction unit 103 extracts <tour-family tour>, <tour-valley> therefrom. Furthermore, the region extraction unit 104 extracts <Japan: 8203000100>, in which 8203000100 is the regional code value for “Japan.” Furthermore, the other information extraction unit 105 extracts the query terms “Japan, family, go, valley, and recommend” and the stop word “recommend.”

FIG. 6 is a diagram showing the internal configuration of the tour destination search unit.

Referring to FIG. 6, the tour destination search unit 20 includes a region-based tour destination search unit 201, a theme-based tour destination search unit 202, a document-based tour destination search unit 203, and a tour destination filtering unit 204.

The region-based tour destination search unit 201 searches the tour destination DB 610 for tour destinations in a corresponding region using the regional information of query analysis results. That is, the region-based tour destination search unit 201 searches for tour destinations in a corresponding region based on the regional limitation information of a user's tour-related query.

The theme-based tour destination search unit 202 searches the tour destination DB 610 for tour destinations corresponding to the theme of the query using the thematic information of the query analysis results. That is, the theme-based tour destination search unit 202 searches for tour destinations suitable for the corresponding theme based on the thematic information of the user's tour-related query.

The document-based tour destination search unit 203 searches for documents using the other information of the query, and retrieves representative POIs attached to the documents as tour destinations. That is, the document-based tour destination search unit 203 searches for tour documents suitable for the tour-related query based on the query term or stop word information of the user's tour-related query, and presents the representative POIs of the corresponding tour documents as tour destination search results.

The tour destination filtering unit 204 removes one or more tour destinations not related to the user's tour-related query using the above-described three types of search results. Here, the current filtering condition is region-based tour destination results AND theme-based tour destination results AND document-based tour destination results. That is, the tour destination filtering unit 204 filters out tour destinations not common to the retrieved tour destination results.

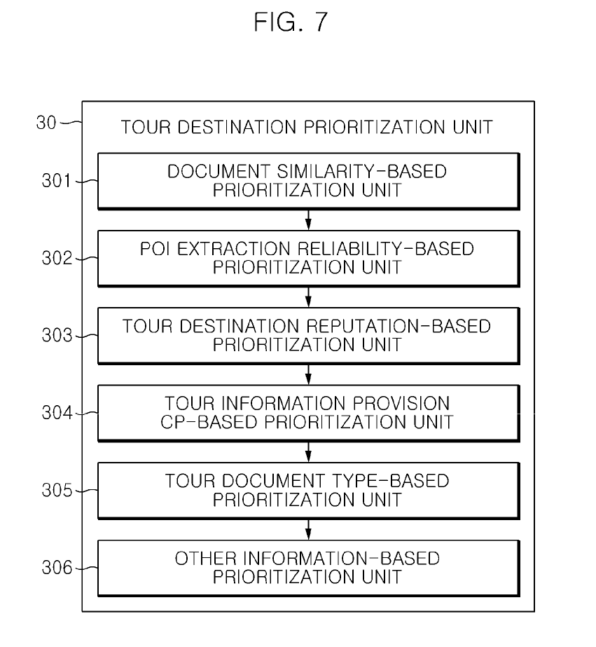

FIG. 7 is a diagram showing the internal configuration of the tour destination prioritization unit.

Referring to FIG. 7, the tour destination prioritization unit 30 includes a document similarity-based prioritization unit 301, a POI extraction reliability-based prioritization unit 302, a tour destination reputation-based prioritization unit 303, a tour information provision CP-based prioritization unit 304, and a tour document type-based prioritization unit 305.

The document similarity-based prioritization unit 301 incorporates the document similarity scores of the tour document search results for the above-described query term into the respective retrieved tour destinations. That is, the document similarity-based prioritization unit 301 incorporates the similarity scores of the tour documents into the reliability of the tour destinations.

The POI extraction reliability-based prioritization unit 302 incorporates the extraction reliability scores of POIs extracted from the documents into the respective tour destinations. That is, the POI extraction reliability-based prioritization unit 302 incorporates the extraction reliability scores of POIs extracted from the documents into the reliability of the tour destinations.

The tour destination reputation-based prioritization unit 303 incorporates the tour destination-based reputation information of the documents into the retrieved tour destinations. That is, the tour destination reputation-based prioritization unit 303 incorporates the reputation information of the tour destinations in the documents into the reliability of the tour destinations.

The tour information provision CP-based prioritization unit 304 incorporates professional tourist agency-based scores, previously calculated based on fame, priority and reputation information, into the retrieved tour destination information based on the professional tourist agencies which provided the tour destination information. That is, the tour information provision CP-based prioritization unit 304 incorporates the reliability information of professional tourist agencies, providing the tour destination information, into the reliability of the tour destinations.

The tour document type-based prioritization unit 305 assigns one of the following level scores depending on the type of source of a tour document. That is, the tour document type-based prioritization unit 305 incorporates a predetermined reliability score into the reliability of the tour destinations depending on the type of document retrieved by the document-based tour destination search unit 203.

For example, the level scores for the types of sources of tour documents may be presented as described below, but are not limited thereto.

Level 1: professional tourist agency documents

Level 2: blog documents

Level 3: general web documents

The other information-based prioritization unit 306 functions to assign additional scores using information which belongs to tour destination information and which is useful for recommendation. Here, useful information includes image information, address information, user review information, and user rating information. That is, the other information-based prioritization unit 306 incorporates additional tour destination-related information, such as image information, address information, user review information, and user rating information, into the reliability of the tour destinations.

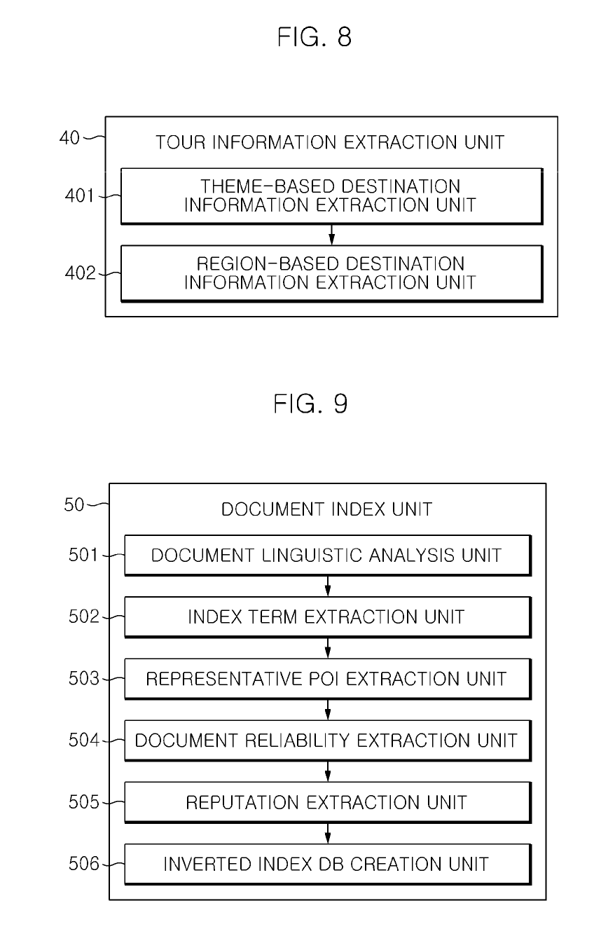

FIG. 8 is a diagram showing the internal configuration of the tour information extraction unit.

Referring to FIG. 8, the tour information extraction unit 40 includes a theme-based tour destination information extraction unit 401, and a region-based tour destination information extraction unit 402. Here, extraction may be performed on refined information acquired from professional tourist agencies and structured information automatically extracted from the web.

The theme-based tour destination information extraction unit 401 extracts tour destination information, such as tour destination names, addresses, and themes, on a theme basis, and organizes it into the tour destination DB 610. The region-based tour destination information extraction unit 402 extracts tour destination information, such as tour destination names, addresses, and themes, on a region basis, and organizes it into the tour destination DB 610.

FIG. 9 is a diagram showing the internal configuration of the document index unit.

Referring to FIG. 9, the document index unit 50 includes a document linguistic analysis unit 501, an index term extraction unit 502, a representative POI extraction unit 503, a document reliability extraction unit 504, a reputation information extraction unit 505, and an inverted index DB creation unit 506. Here, indexing may be performed on tour documents constructed by professional tourist agencies or automatically collected from the web.

The document linguistic analysis unit 501 applies linguistic analysis technology to the titles and bodies of documents, and performs morpheme analysis and named entity recognition. That is, the document linguistic analysis unit 501 performs morpheme analysis and named entity recognition on refined documents provided by professional tourist agencies or web tour documents automatically collected from the web.

The index term extraction unit 502 extracts significant index terms, that is, names, words with declined or conjugated endings and adverbs, using linguistic analysis results. That is, the index term extraction unit 502 extracts significant keywords useful for searching using linguistic analysis results.

The representative POI extraction unit 503 analyzes POIs appearing in documents, and extracts principal POIs which can be representative of respective documents. That is, the representative POI extraction unit 503 extracts all POIs appearing in documents, prioritizes the extracted POIs, and chooses principal POIs which can be representative of the documents.

The document reliability extraction unit 504 calculates the reliability of each document itself based on the source, date and document quality score of the document. That is, the document reliability extraction unit 504 calculates the reliability of each document itself based on the source, date and document quality score of the document.

The reputation information extraction unit 505 extracts user reputation information from objects appearing in document and calculates the reputation scores of POIs. That is, the reputation information extraction unit 505 extracts user reputation information from objects appearing in documents, and calculates the reputation scores of POIs.

The inverted index DB creation unit 506 creates an inverted index DB (not shown) so that all the above-described extracted information can be searched. That is, the inverted index DB creation unit 506 constructs an inverted index DB so that all extracted information can be used for searching.

The present invention has the advantage that desired tour destination information can be searched for on a natural language basis.

Furthermore, the present invention has the advantage that users can easily ask desired queries because tour information is not searched for by users entering values into structured information predefined by a system but users can freely make queries in a natural language.

Furthermore, the present invention has the advantage that tour destinations suitable for a user's intention can be searched for by applying linguistic analysis to the user's natural language query and thereby extracting POI information, thematic information, and regional information, and the advantage that reliability (or accuracy) can be improved by presenting tour destinations suitable for the user's intention in order of priority based on a variety of types of reliability scores, such as document similarity scores, POI extraction reliability, tour destination reputation information, CP reliability, and document reliability.

A tour destination recommendation process based on the natural language-based tour destination recommendation method according to an embodiment of the present invention will be described in detail below with reference to the accompanying drawings. In the following description, components identical to those shown in FIGS. 1 to 9 have the same functionality. The following description will be given on the basis of the example shown in FIG. 5.

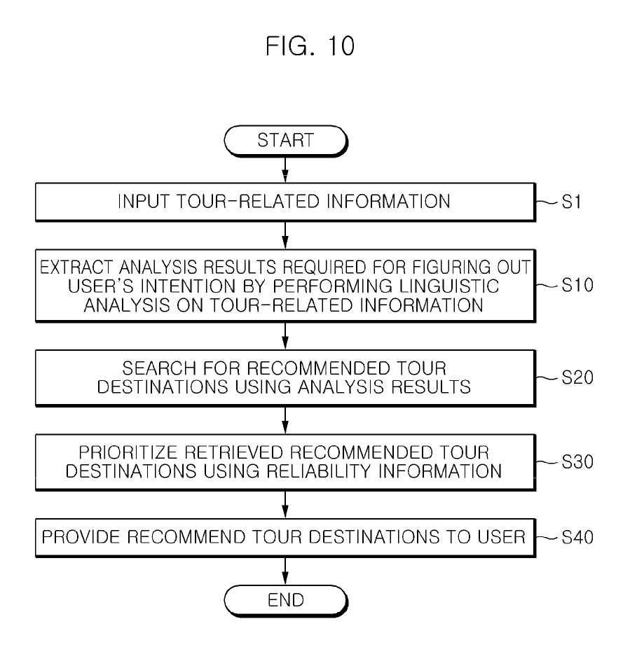

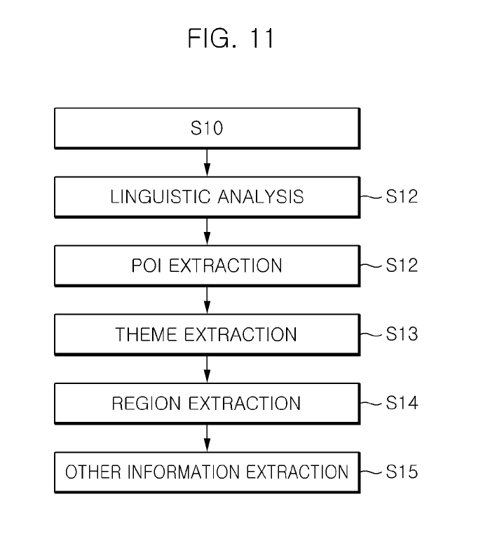

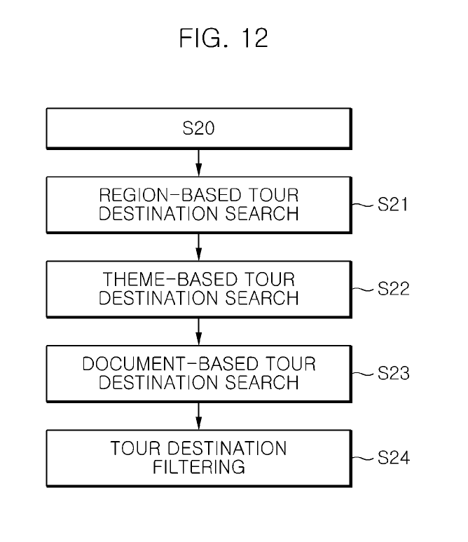

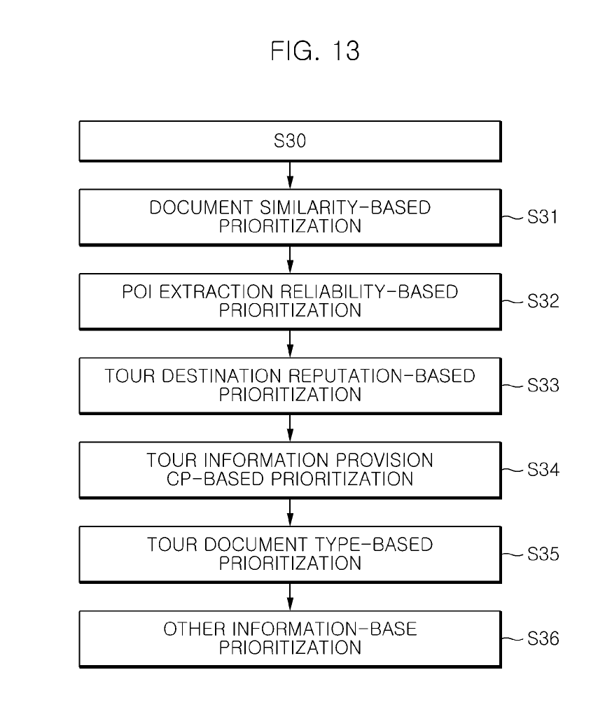

FIG. 10 is a flowchart showing the flow of the natural language-based tour destination recommendation method according to the present invention, FIG. 11 is a flowchart showing the detailed flow of step S10 of FIG. 10, FIG. 12 is a flowchart showing the detailed flow of step S20 of FIG. 10, and FIG. 13 is a flowchart showing the detailed flow of step S30 of FIG. 10.

Referring to FIG. 10 first, a user's tour-related query is input through a user interface (not shown) at step S1. For example, the user inputs a query in a natural language (language) using a keypad or a touchpad. For example, the user inputs the query “recommend valleys in Japan which are fit for my family to go.”

Thereafter, the query analysis unit 10 extracts query analysis information matching linguistic analysis results by applying linguistic analysis to the input user's tour-related query and searching the document index DB 620 in stages at step S10. For example, for the tour-related query “recommend valleys in Japan which are fit for my family to go,” the query analysis information <address POI=Japan>, <tour-family tour>, <tour-valley>, <Japan: 8203000100>, query terms: Japan, family, go, valley, and recommend, and stop word: recommend is extracted.

Thereafter, the tour destination search unit 20 searches the tour destination DB 610 for recommended tour destinations matching the extracted query analysis information at step S20. For example, region-based tour destinations (tour destinations corresponding to Japan), theme-based tour destinations (tour destinations corresponding to tour-family tour, tour-valley), and document search-based tour destinations (tour destinations corresponding to the query terms: Japan, family, go, valley, and recommend, and stop word: recommend) are searched for.

Thereafter, the tour destination prioritization unit 30 prioritizes the retrieved tour destinations using various document analysis results and previously calculated tour destination reliability information at step S30. For example, points or levels are assigned to each of the retrieved recommended tour destinations based on corresponding reliability information, that is, a document similarity score, a POI extraction reliability score, a tour destination reputation score, a tour information provision CP reliability score, a tour document-type reliability score, and other reliability scores.

Meanwhile, the tour destination prioritization unit 30 removes one or more recommended tour destinations not corresponding to the user's tour-related query [symbol] corresponding from the retrieved recommended tour destinations by filtering the retrieved recommended tour destinations. For example, recommended tour destination not retrieved in common are removed by applying an AND condition to recommended tour destination groups retrieved for region, theme, document-based tour destinations.

Finally, the tour destination recommendation and provision unit 40 provides recommended tour destinations suitable for the above-described user's tour-related query finally at step S40. For example, results in which a plurality of recommended tour destinations corresponding to the user's tour-related query have been prioritized is provided in the form of a recommended tour destination list.

The above-described step S10 will now be described in detail with reference to FIG. 11.

First, the query linguistic analysis unit 101 performs linguistic analysis by dividing the user's tour-related query into morphemes or matching named entities with words at step at step S11.

Thereafter, the POI extraction unit 102 extracts POIs appearing in the query using linguistic analysis results obtained for the above-described user's tour-related query at step S12. For example, <address POI=Japan> may be extracted.

Thereafter, the theme extraction unit 103 selects the theme of the query from among predefined theme categories at step S13. For example, <tour-family tour> or <tour-valley> may be extracted.

Furthermore, the region extraction unit 104 extracts regional information appearing in the query using the linguistic analysis results at step S14. For example, <Japan: 8203000100> may be extracted.

The other information extraction unit 105 extracts one or more query terms or stop words usable for document searching or filtering using the linguistic analysis results at step S15. For example, the query terms “Japan, family, go, valley, and recommend, and the stop word “recommend” may be extracted.

Step S20 will now be described in detail with reference to FIG. 12.

First, the region-based tour destination search unit 201 searches the tour destination DB 610 for tour destinations in a corresponding region using the regional information of the query analysis results at step S21.

Thereafter, the theme-based tour destination search unit 202 searches the tour destination DB 610 for tour destinations corresponding to the theme of the query using the thematic information of the query analysis results at step S22.

Thereafter, the document-based tour destination search unit 203 searches for documents using the other information of the query and retrieves representative POIs attached to the documents as tour destinations at step S23.

Finally, the tour destination filtering unit 204 removes tour destinations not related to the user's tour-related query using the above-described three types of search results at step S24.

Step S30 will now be described in detail with reference to FIG. 13.

First, the document similarity-based prioritization unit 301 incorporates the document similarity scores of tour document search results for the above-described query term into the respective retrieved tour destinations at step S31.

Thereafter, the POI extraction reliability-based prioritization unit 302 incorporates the extraction reliability scores of POIs extracted from the documents into the respective retrieved tour destinations at step S32.

Thereafter, the tour destination reputation-based prioritization unit 303 incorporates the tour destination-based reputation information of the documents into the respective retrieved tour destinations at step S33.

Furthermore, the tour information provision CP-based prioritization unit 304 incorporates professional tourist agency-based scores, previously calculated based on the frame, priority and reputation information, into the retrieved tour destination information based on professional tourist agencies which provided the retrieved tour destination information at step S34.

Thereafter, the tour document type-based prioritization unit 305 assigns one of the following level scores depending on the type of source of a tour document at step S35. For example, the level scores may include Level1 for professional tourist agency documents, Level2 for blog documents, and Level3 for general web documents.

Finally, the other information-based prioritization unit 306 assigns additional scores using information which belongs to the tour destination information and is useful for recommendation at step S36. For example, this useful information may include image information, address information, user review information, and user rating information.

As described above, the present invention has the advantage that convenience can be provided to users because tour information, such as recommended tour destinations, retrieved on a natural language basis can be provided by performing linguistic analysis on users' natural language-based tour-related queries.

Furthermore, the present invention has the advantage that more useful tour information can be provided because tour destinations suitable for users' intention using query analysis information, such as POI information, thematic information and regional information, extracted from linguistic analysis results.

Moreover, the present invention has the advantage that tour destinations most suitable for users' intention can be presented because retrieved recommended tour destinations are prioritized based on a variety of types of reliability scores, such as document similarity scores, POI extraction reliability, tour destination reputation information, CP reliability, and document reliability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A natural language-based tour destination recommendation apparatus, comprising:
a query analysis unit for performing linguistic analysis on a user's tour-related query and then extracting query analysis information from a document index Database (DB) to be used for figuring out the user's intention;
a tour destination search unit for searching a tour destination DB for one or more recommended tour destinations using the extracted query analysis information; and
a tour destination recommendation and provision unit for providing the retrieved recommended tour destinations to the user.

2. The natural language-based tour destination recommendation apparatus as set forth in claim 1, wherein the query analysis information comprises Point of Interest (POI) information, thematic information, regional information and/or other information.

3. The natural language-based tour destination recommendation apparatus as set forth in claim 1, wherein the recommended tour destinations comprise one or more region-based tour destinations, one or more theme-based tour destinations and/or one or more document searching-based tour destinations.

4. The natural language-based tour destination recommendation apparatus as set forth in claim 1, further comprising a tour destination prioritization unit for prioritizing the recommended tour destinations using reliability information of the document index DB.

5. The natural language-based tour destination recommendation apparatus as set forth in claim 4, wherein the reliability information comprises at least one of a document similarity score, a POI extraction reliability score, a tour destination reputation score, a tour information provision CP reliability score, a tour document-type reliability score, and other reliability scores.

6. The natural language-based tour destination recommendation apparatus as set forth in claim 4, wherein the tour destination prioritization unit filters out one or more tour destinations not corresponding to the user's tour-related query from the recommended tour destinations.

7. The natural language-based tour destination recommendation apparatus as set forth in claim 1, further comprising a tour information extraction unit for classifying tour destinations on a theme or region basis and organizing the classified tour destinations into the tour destination DB.

8. The natural language-based tour destination recommendation apparatus as set forth in claim 1, further comprising a document index unit for extracting an index term, a representative POI, document reliability and/or reputation information from each tour document and organizing the extracted information into the document index DB.

9. The natural language-based tour destination recommendation apparatus as set forth in claim 1, wherein the query analysis unit comprises:
a query linguistic analysis unit for performing linguistic analysis on the user's tour-related query using morpheme analysis and named entity recognition;
a POI extraction unit for extracting POIs appearing in the user's tour-related query using the linguistic analysis results;
a theme extraction unit for extracting thematic information of the user's tour-related query using the linguistic analysis results; and
a region extraction unit for extracting regional limitation information of the user's tour-related query using the linguistic analysis results.

10. The natural language-based tour destination recommendation apparatus as set forth in claim 9, wherein the query analysis unit further comprises an other information extraction unit for extracting one or more query term or stop words using the linguistic analysis results so that they can be used for document searching for the user's tour-related query [symbol] document.

11. The natural language-based tour destination recommendation apparatus as set forth in claim 1, wherein the tour destination search unit comprises:
a region-based tour destination search unit for searching for tour destinations in a corresponding region based on regional limitation information of the user's tour-related query; and
a theme-based tour destination search unit for searching for tour destinations related to a corresponding theme using thematic information of the user's tour-related query.

12. The natural language-based tour destination recommendation apparatus as set forth in claim 11, wherein the tour destination search unit further comprises a document-based tour destination search unit for searching for representative Points of Interest (POIs) of one or more corresponding tour documents based on the query term or stop word information of the user's tour-related query.

13. The natural language-based tour destination recommendation apparatus as set forth in claim 12, wherein the tour destination search unit further comprises a tour destination filtering unit for filtering out tour destinations not common to the retrieved groups of tour destination results.

14. The natural language-based tour destination recommendation apparatus as set forth in claim 4, wherein the tour destination prioritization unit comprises:
a document similarity-based prioritization unit for incorporating a similarity score of each tour document into reliability of a corresponding one of the recommended tour destinations;
a POI extraction reliability-based prioritization unit for incorporating extraction reliability of a POI extracted from each tour document into reliability of a corresponding one of the recommended tour destinations;
a tour destination reputation-based prioritization unit for incorporating reputation information of a tour destination in each document into reliability of a corresponding one of the recommended tour destinations;
a tour information provision CP-based prioritization unit for incorporating reliability information of a professional tourist agency providing each piece of tour destination information into reliability of a corresponding one of the recommended tour destinations;
a tour document type-based prioritization unit for incorporating a predetermined reliability score into reliability of a corresponding one of the recommended tour destinations a type of document retrieved by the document-based tour destination search unit; and
an other information-based prioritization unit for incorporating additional tour destination-related information, such as image information, address information, user review information and/or user rating information, into reliability of a corresponding one of the recommended tour destinations.

15. The natural language-based tour destination recommendation apparatus as set forth in claim 8, wherein the document index unit comprises:
a document linguistic analysis unit for performing morpheme analysis and named entity recognition on refined documents provided by professional tourist agencies or web tour documents automatically collected from a web;
an index term extraction unit for extracting significant keywords useful for searching using linguistic analysis results;
a representative POI extraction unit for extracting POIs appearing in the documents, prioritizing the extracted POIs, and choosing principal POIs representative of the documents;
a document reliability extraction unit for calculating reliability of the documents themselves based on sources, dates and document quality scores of the documents; and
a reputation information extraction unit for extracting user reputation information from objects appearing in the documents and calculating reputation scores of the POIs.

16. The natural language-based tour destination recommendation apparatus as set forth in claim 15, wherein the document index unit further comprises an inverted index DB creation unit for constructing an inverted index DB so that all the extracted information can be used for searching.

17. A natural language-based tour destination recommendation method, comprising:
performing linguistic analysis on a user's tour-related query and then extracting query analysis information to be used for figuring out the user's intention from a document index DB;
searching a tour destination DB for one or more recommended tour destinations using the extracted query analysis information; and
providing the retrieved recommended tour destinations to the user.

18. The natural language-based tour destination recommendation method as set forth in claim 17, wherein the query analysis information comprises POI information, thematic information, regional information and/or other information.

19. The natural language-based tour destination recommendation method as set forth in claim 17, wherein the recommended tour destinations comprise one or more region-based tour destinations, one or more theme-based tour destinations and/or one or more document searching-based tour destinations.

20. The natural language-based tour destination recommendation method as set forth in claim 17, further comprising prioritizing the recommended tour destinations using reliability information of the document index DB.
